(19) United States
(12) Patent Application Publication
(10) Pub. No.: US 2005/0061199 A1
(43) Pub. Date: Mar. 24, 2005

(54) Fluorescent water base ink for ink-jet recording

(75) Inventors: Masashi Tsuda, Haguri-gun (JP); Hiromitsu Sago, Tokai-shi (JP); Michiko Aoyama, Nagoya-shi (JP); Mayuko Umemura, Chiryu-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 10/946,097

(22) Filed: Sep. 22, 2004

(30) Foreign Application Priority Data
Sep. 24, 2003 (JP) 2003-331983
Sep. 6, 2004 (JP) 2004-258074

(51) Int. Cl. C09D 11/00; C09K 11/06

(52) U.S. Cl. 106/31.15; 252/301.16; 106/31.32; 106/31.58

(57) ABSTRACT

Fluorescent water base ink for ink-jet recording contains water, a fluorescent dye having a skeleton for emitting fluorescence, and a polyol having not less than two hydroxyl groups. A distance between oxygen and oxygen of the two hydroxyl groups in the polyol is substantially equal to or longer than a length of the skeleton of the fluorescent dye. When the fluorescent dye has a xanthene skeleton, 1,5-pentanediol can be used as the polyol. The ink has the high fluorescence intensity.

### BACKGROUND OF THE INVENTION

1. Field of the Invention

The present invention relates to a fluorescent water base ink for ink-jet recording having a high fluorescence intensity.

2. Description of the Related Art

In the ink-jet recording system, ink droplets are formed by the ink discharge system including, for example, the electrostatic attraction method, the method in which mechanical vibration or displacement is applied to the ink by using a piezoelectric element or the like, and the method in which bubbles are generated by heating the ink to utilize the pressure generated thereby. All or a part of the ink droplets are adhered to a recording medium such as paper to perform the recording. The ink-jet recording method does not involve the process including, for example, those for the development and the fixation, in which it is easy to realize the color printing. Therefore, in recent years, the ink-jet recording method has remarkably come into widespread use. Recently, the high definition printing and the high speed printing based on the ink-jet printer are rapidly advanced. Further, for example, the color printer, which is capable of performing the printing on regular paper, is dominantly used.

In such circumstances, the following research has been advanced. That is, the fluorescent property is added to the ink for ink-jet recording, and information including, for example, letters, numerals, symbols, and bar codes is recorded on the recording medium with the fluorescent ink so that the fluorescent ink is allowed to cause light emission by radiating the ultraviolet light having an appropriate wavelength. Accordingly, fluorescent information is added in addition to visible information. For example, Japanese Patent Application Laid-open No. 9-291246 corresponding to U.S. Pat. No. 5,681,381 discloses a water resistant water base fluorescent ink for imprinting postal indicia. The fluorescent ink includes not only transparent inks having no absorption in the visible region but also color inks having any absorption in the visible region. The color fluorescent ink, which has the absorption in the visible region, makes it possible to recognize information even visually. It is possible to select a reading means depending on the contents of information. Therefore, it is expected that the versatility of the ink is widened.

However, in general, in the case of the fluorescent ink, it is known that the concentration quenching phenomenon occurs as follows. That is, when the concentration of the fluorescent dye contained in the ink exceeds a certain amount, the absorbed energy is subjected to the transition to a state in which no light is emitted to pass through the non-radiation process due to the interaction of the excited fluorescent dye. As a result, the fluorescence intensity is all the more decreased. Therefore, the following problem arises. That is, even when the concentration of the fluorescent dye is adjusted in any way, it is impossible to obtain any fluorescent ink with a fluorescence intensity which exceeds a certain amount.

### SUMMARY OF THE INVENTION

The present invention has been made in order to solve the problem as described above, an object of which is to provide a fluorescent water base ink for ink-jet recording having a high fluorescence intensity.

According to the present invention, there is provided a fluorescent water base ink for ink-jet recording, comprising:

a fluorescent dye having a skeleton for emitting fluorescence; and

a polyol having not less than two hydroxyl groups, wherein:

a distance between oxygen and oxygen of the two hydroxyl groups in the polyol is substantially equal to or longer than a length of the skeleton of the fluorescent dye. The fluorescent water base ink for ink-jet recording of the present invention uses the fluorescent dye and the specified polyol in combination. Therefore, it is possible to increase the fluorescence intensity in accordance with the function as described later on.

According to the present invention, there is also provided an ink cartridge comprising the ink of the present invention. The ink cartridge includes a container which may have any arbitrary shapes for accommodating the ink. The ink cartridge may be carried on an ink-jet head, or the ink cartridge may be attached to the inside of a main body case of an ink-jet recording apparatus. In the case of the latter, the ink is supplied from the ink cartridge to the ink-jet head, for example, through a flexible tube.

### BRIEF DESCRIPTION OF THE DRAWINGS

FIG. 1 shows a graph illustrating the relationship between the fluorescence intensity and the molar ratio of polyol to the fluorescent dye used in Examples and Comparative Examples.

### DESCRIPTION OF THE PREFERRED EMBODIMENTS

The fluorescent water base ink for ink-jet recording of the present invention contains the fluorescent dye and the polyol. The fluorescent dye is not specifically limited provided that the fluorescent dye absorbs exciting light having a certain wavelength to emit fluorescence. The fluorescent dye may include, for example, C.I. Basic Red 1, 2, 9, 12, 13, 14, 17; C.I. Basic Violet 1, 3, 7, 10, 11:1, 14; C.I. Acid Red 51, 52, 87, 92, 94; C.I. Direct Yellow 11, 24, 26, 87, 100, 132, 147; C.I. Direct Orange 26, 29, 29:1, 46; C.I. Direct Red 1, 13, 17, 239, 240, 242, 254; C.I. Solvent Yellow 44, 82, 94, 116; C.I. Solvent Red 43, 44, 45, 48, 49, 60, 72; C.I. Solvent Blue 5; and C.I. Solvent Green 7. The fluorescent dye as described above may be used singly. Alternatively, two or more of the fluorescent dyes may be used in combination.

The content of the fluorescent dye may be 0.1 to 3.0% by weight with respect to the total amount of the fluorescent water base ink for ink-jet recording. If the content is less than 0.1% by weight, it is difficult to obtain any sufficient fluorescence intensity in some cases. If the content exceeds 3.0% by weight, then the concentration quenching phenomenon occurs, and the fluorescence intensity is inversely lowered in some cases. More preferably, the content is 0.3 to 1.5% by weight.

The polyol is not specifically limited provided that the polyol has two or more hydroxyl groups in one molecule. However, if the number of carbon atoms exceeds 8, then the solubility in the water base ink is inferior, and it is difficult to contain the polyol in such an amount that the effect to improve the fluorescence intensity is sufficiently exhibited. Therefore, it is preferable to use the polyol having a number of carbon atoms of not more than 8. The polyol as described above may include, for example, 1,3-propanediol, 1,4-butanediol, 1,5-pentanediol, 1,6-hexanediol, 1,7-heptanediol, 1,8-octanediol, 1,2,4-butanetriol, and 1,2,6-hexanetriol. The polyol as described above may be used singly. Alternatively, two or more of the polyols as described above may be used in combination.

The polyol, in which the distance between oxygen and oxygen of the two hydroxyl groups of the polyol is substantially equal to or longer than the length of the skeleton of the fluorescent dye, is used as the polyol as described above. The phrase “substantially equal to” herein means the fact that the distance between oxygen and oxygen of the two hydroxyl groups of the polyol is within a range of 80% to 120% of the length of the skeleton in the fluorescent dye for emitting fluorescence. If the distance is less than 80%, it is considered that the polyol cannot form the ring structure together with the fluorescent dye in accordance with the function as described later on. On the other hand, if the distance between oxygen and oxygen of the two hydroxyl groups of the polyol exceeds 200% of the length of the skeleton of the fluorescent dye, it is considered that the polyol cannot form the ring structure together with the fluorescent dye as well. More preferably, the distance between oxygen and oxygen of the two hydroxyl groups of the polyol is 90 to 150% of the length of the skeleton of the fluorescent dye.

In the present invention, the distance between oxygen and oxygen of two hydroxyl groups of the polyol means the distance between the center of oxygen atom of one hydroxyl group in the molecule and the center of oxygen atom of another hydroxyl group. The distance can be calculated, for example, by using a software such as Chem 3D produced by Fujitsu. The distance between oxygen and oxygen of two hydroxyl groups of the polyol, which is described in this specification, is represented by the distance obtained by depicting the molecular structure of the polyol with Chem 3D produced by Fujitsu, and then performing “Minimize Energy” (energy minimization) with Chem 3D. When three or more hydroxyl groups are included in one molecule, it is enough that at least two hydroxyl groups satisfy the requirement described above. For example, the distance between oxygen and oxygen of two hydroxyl groups of 1,3-propanediol is 4.8 angstroms, the distance between oxygen and oxygen of two hydroxyl groups of 1,4-butanediol is 6.2 angstroms, the distance between oxygen and oxygen of two hydroxyl groups of 1,5-pentanediol is 7.5 angstroms, the distance between oxygen and oxygen of two hydroxyl groups of 1,6-hexanediol is 8.7 angstroms, the distance between oxygen and oxygen of two hydroxyl groups of 1,7-heptanediol is 9.9 angstroms, the distance between oxygen and oxygen of two hydroxyl groups of 1,8-octanediol is 11.2 angstroms, the distance between oxygen and oxygen of 1-position and 4-position hydroxyl groups of 1,2,4-butanetriol is 5.0 angstroms, and the distance between oxygen and oxygen of 2-position and 4-position hydroxyl groups thereof is 2.9 angstroms. The distance between oxygen and oxygen of 1-position and 6-position hydroxyl groups of 1,2,6-hexanetriol is 8.7 angstroms, and the distance between oxygen and oxygen of 2-position and 6-position hydroxyl groups thereof is 6.6 angstroms.

The skeleton of the fluorescent dye, which emits the fluorescence, includes, for example, xanthene, naphthalene, anthracene, and naphthacene. In this specification, the length of the skeleton for emitting fluorescence of the fluorescent dye means the length of the basic molecular skeleton or backbone of the molecule as the fluorescent dye, i.e., the length of the molecule of a portion obtained by excluding any modified portion, for example, when the modification is made. For example, C.I. Acid Red 52 has the molecular structure represented by the following formula (1). The basic molecular skeleton thereof to emit fluorescence is the portion represented by the following formula (2), i.e., xanthene. Therefore, the length of the skeleton of C.I. Acid Red 52 which emits fluorescence is the distance between the 3-position carbon and the 6-position carbon of the xanthene skeleton, which is 7.5 angstroms. Further, for example, the basic molecular skeletons of C.I. Solvent Red 49 and C.I. Solvent Yellow 94 are also xanthene represented by the formula (2). Therefore, the polyol, which can be used in combination with the fluorescent dye having the xanthene skeleton on the basis of the present invention, preferably includes, for example, 1,5-pentanediol, 1,6-hexanediol, and 1,2,6-hexanetriol as exemplified above.

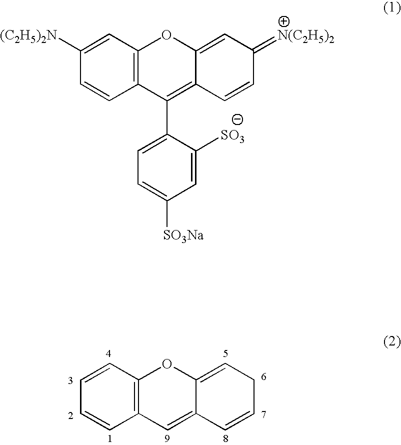

The inventors have found out the fact that the fluorescence intensity of the fluorescent ink is extremely increased by using the fluorescent dye and the specified polyol in combination. The reason for this fact is considered as follows. That is, the hydroxyl groups of the polyol act on the atoms disposed at the terminals of the molecular skeleton for emitting fluorescence of the fluorescent dye, i.e., on the 3-position carbon and the 6-position carbon in the case of the xanthene skeleton respectively to form a type of ring structure by the fluorescent dye and the polyol. Owing to this ring structure, the fluorescent dye tends to be excited.

It is preferable that the amount of use of the polyol with respect to the fluorescent dye as described above is not less than 6 as represented by the molar ratio of the polyol to the fluorescent dye in order to sufficiently enhance the fluorescence intensity. It is more preferable that the amount of use or the molar ratio of the polyol is not less than 84 in case of C.I. Acid Red 52. It is furthermore preferable that the amount of use or the molar ratio of the polyol is not less than 100, and especially not less than 200 depending on the fluorescent dye to be used, for example, not less than 212 in the case of C.I. Solvent Red 49.

It is preferable that the content of the polyol with respect to the total amount of the water base ink for ink-jet recording is 5 to 40% by weight. If the content is less than 5% by weight, then any sufficient fluorescence intensity is not obtained, and the fluorescence intensity is sometimes lowered after the recording. If the content exceeds 40% by weight, the ink viscosity is too increased, which is not desirable.

The fluorescent water base ink for ink-jet recording of the present invention may contain water. Those preferably usable as the water include those having small contents of cationic ions and anionic ions, such as ion exchange water and distilled water other than ordinary water. It is preferable that the content of the water is 50 to 75% by weight with respect to the total amount of the fluorescent water base ink for ink-jet recording depending on, for example, the composition and the type of the polyol and the fluorescent dye to be used as well as the characteristics of the desired ink. If the content is less than 50% by weight, the ratio of the components other than water is necessarily increased. Therefore, the ink is blurred when the printing is performed on the paper. Further, the viscosity is increased. As a result, it is difficult to introduce the ink into the nozzles in some cases. If the content exceeds 75% by weight, the ink viscosity is too increased after the volatile components are evaporated, sometimes resulting in the occurrence of discharge failure.

A dye or a pigment, which is hitherto known, may be also contained as a color tone-adjusting agent in the fluorescent water base ink for ink-jet recording of the present invention. However, the fluorescence of the fluorescent dye is sometimes inhibited to conspicuously lower the fluorescence intensity depending on the amount of addition and the type of the dye or the pigment. Therefore, it is necessary to select the type and the amount so that no influence is exerted on the fluorescence intensity.

The fluorescent water base ink for ink-jet recording of the present invention is basically composed of the above-described ingredients. However, it is also allowable to contain, for example, conventionally known various moistening agents, permeating agents, surfactants, viscosity-adjusting agents, surface tension-adjusting agents, pH-adjusting agents, metal rust-preventive agents, specific resistance-adjusting agents, film-forming agents, ultraviolet-absorbing agents, antioxidizing agents, antifading agents, and antiseptic/fungicidal agents depending on the purpose to improve various performance including, for example, the discharge stability, the adaptability with respect to materials for the head and the ink cartridge, the storage stability, the image storage performance and the like. When the fluorescent water base ink for ink-jet recording of the present invention is applied to the ink-jet system in which the jetting operation is performed in accordance with the action of thermal energy, it is also allowable to adjust thermal physical values including, for example, the specific heat, the coefficient of thermal expansion, and the coefficient of thermal conductivity.

The present invention will be explained in further detail below as exemplified by Examples. However, the present invention is not limited to only Examples.

### EXAMPLES 1 TO 7

Ink materials having compositions containing polyol as shown in Table 1 were agitated while using fluorescent dyes of C.I. Acid Red 52, C.I. Solvent Red 49, and C.I. Solvent Yellow 94, followed by being filtrated through a membrane filter of 0.2 μm to prepare inks. Among the ink components, glycerol was used as a moistening agent, and triethylene glycol monobutyl ether and dipropylene glycol propyl ether were used as permeating agents respectively. In Table 1, the concentrations of the respective components are indicated by % by weight. L represents the length of the skeleton for emitting fluorescence of the fluorescent dye, and O/O represents the distance between oxygen and oxygen of two hydroxyl groups of polyol. In the case of 1,2,6-hexanetriol, the distance between oxygen and oxygen of 1-position and 6-position hydroxyl groups is shown. In any one of Examples, the distance between oxygen and oxygen of the hydroxyl groups of polyol was substantially equal to or longer than the length of the skeleton for emitting fluorescence of the fluorescent dye.

### Comparative Examples 1 to 4

Ink materials having compositions containing polyol as shown in Table 2 were agitated while using fluorescent dyes of C.I. Acid Red 52 and C.I. Solvent Red 49, followed by being filtrated through a membrane filter of 0.2 μm to prepare inks. Among the ink components, glycerol and polyethylene glycol #200 were used as moistening agents respectively. Triethylene glycol monobutyl ether and dipropylene glycol propyl ether were used as permeating agents respectively. In Table 2, the concentrations of the respective components are indicated by % by weight. L represents the length of the skeleton for emitting fluorescence of the fluorescent dye, and O/O represents the distance between oxygen and oxygen of two hydroxyl groups of polyol. In any one of Comparative Examples, the distance between oxygen and oxygen of the hydroxyl groups of polyol was shorter than 80% of the length of the skeleton for emitting fluorescence of the fluorescent dye.

### Evaluation

Recording was performed on regular paper by using an ink-jet printer (MFC-5100J produced by Brother Industries, Ltd.) with the inks prepared in Examples 1 to 7 and Comparative Examples 1 to 4. A portion, which had a coating ratio of 100%, was used as a recording sample. The fluorescence intensity of the recording sample, which was brought about 1 hour after the recording, was measured to obtain the peak intensity by using a fluorescence spectrophotometer (F-4500 produced by Hitachi). The fluorescence intensity was judged on the basis of the obtained peak intensity in accordance with the following criteria. The wavelength of the exciting light source was 254 nm during the measurement of the fluorescence intensity. The fluorescence intensity was measured at a wavelength of 600 nm in Examples 1 to 6 and Comparative Example 1 and 2 and at a wavelength of 530 nm in Example 7 and Comparative Examples 3 and 4. The fluorescence intensity was evaluated in accordance with the following criteria. ++: The measured value of the fluorescence intensity was not less than 400. +: The measured value of the fluorescence intensity was not less than 270 and less than 400. +: The measured value of the fluorescence intensity was not less than 200 and less than 270. −: The measured value of the fluorescence intensity was less than 200. The measured value of the measured fluorescence intensity and the evaluation thereof are added in Tables 1 and 2.

TABLE 1

| Ink composition | | Ex. 1 | Ex. 2 | Ex. 3 | Ex. 4 | Ex. 5 | Ex. 6 | Ex. 7 |
|---|---|---|---|---|---|---|---|---|
| Fluorescent dye | C. I. Acid Red 52 (L = 7.5 Å) | 1.0 | 1.0 | 1.0 | — | — | — | — |
| | C. I. Solvent Red 49 (L = 7.5 Å) | — | — | — | 0.5 | 0.5 | 0.5 | — |
| | C. I. Solvent Yellow 94 | — | — | — | — | — | — | 0.5 |
| | (L = 7.5 Å) | | | | | | | |
| Polyol | 1,5-pentanediol (O/O = 7.5 Å) | 25.0 | — | 10.0 | 15.0 | 25.0 | — | 25.0 |
| | 1,2.6-hexanetriol (O/O = 8.7 Å) | — | 25.0 | 15.0 | — | — | — | — |
| | 1,6-hexanediol (O/O = 8.7 Å) | — | — | — | — | — | 15.0 | — |

| | | | | | | | |
|---|---|---|---|---|---|---|---|
| Glycerol | 15.0 | 15.0 | 15.0 | 25.0 | 15.0 | 25.0 | 15.0 |
| Triethylene glycol monobutyl ether | 5.0 | 5.0 | 5.0 | — | — | — | — |
| Dipropylene glycol propyl ether | — | — | — | 2.0 | 2.0 | 2.0 | 2.0 |
| Distilled water | 54.0 | 54.0 | 54.0 | 57.5 | 57.5 | 57.5 | 57.5 |
| Fluorescence intensity | 430 | 400 | 410 | 340 | 400 | 320 | 350 |
| Evaluation | ++ | ++ | ++ | + | ++ | + | + |
| Polyol/fluorescent dye (molar ratio) | 139 | 108 | 121 | 127 | 212 | 112 | 160 |

TABLE 2

| | | Comp. | Comp. | Comp. | Comp. |
|---|---|---|---|---|---|
| Ink composition | | Ex. 1 | Ex. 2 | Ex. 3 | Ex. 4 |
| Fluorescent | C. I. Acid Red 52 | 1.0 | 1.0 | — | — |
| dye | (L = 7.5 Å) | | | | |
| | C. I. Solvent Red 49 | — | — | 0.5 | 0.5 |
| | (L = 7.5 Å) | | | | |
| Polyol | 1,2-pentanediol | 25.0 | — | — | — |
| | (O/O = 2.7 Å) | | | | |
| | 1,3-propanediol | — | 25.0 | 15.0 | — |
| | (O/O = 4.8 Å) | | | | |

| | | | | |
|---|---|---|---|---|
| Glycerol | 15.0 | 15.0 | 25.0 | 15.0 |
| Polyethylene glycol #200 | — | — | — | 25.0 |
| Triethylene glycol monobutyl ether | 5.0 | 5.0 | — | — |
| Dipropylene glycol propyl ether | — | — | 2.0 | 2.0 |
| Distilled water | 54.0 | 54.0 | 57.5 | 57.5 |
| Fluorescence intensity | 190 | 230 | 220 | 180 |
| Evaluation | — | ± | ± | — |
| Polyol/fluorescent dye | 139 | 191 | 174 | — |
| (molar ratio) | | | | |

### EXAMPLES 8 TO 11

In relation to the ink prepared in Example 1, the ink composition, especially the amount of use of 1,5-pentanediol with respect to C.I. Acid Red 52 was changed to have various values as shown in Table 3 to prepare inks. The fluorescence intensity was measured and evaluated for the respective prepared inks in the same manner as in Example 1. Obtained results are shown in Table 3.

TABLE 3

| | | | | Example |
|---|---|---|---|---|
| Component | Example 8 | Example 9 | Example 10 | 11 |
| C. I. Acid Red 52 | 1 | 1 | 1 | 1 |
| 1,5-Pentanediol | 15 | 5 | 1 | 40 |
| Glycerol | 15 | 15 | 15 | 15 |
| Triethylene glycol | 5 | 5 | 5 | 5 |
| monobutyl ether | | | | |
| Distilled water | 64 | 74 | 78 | 39 |
| Total | 100 | 100 | 100 | 100 |
| Fluorescence intensity | 420 | 360 | 280 | 400 |
| Evaluation | ++ | + | + | ++ |
| Polyol/fluorescent dye | 84 | 28 | 6 | 223 |
| (molar ratio) | | | | |

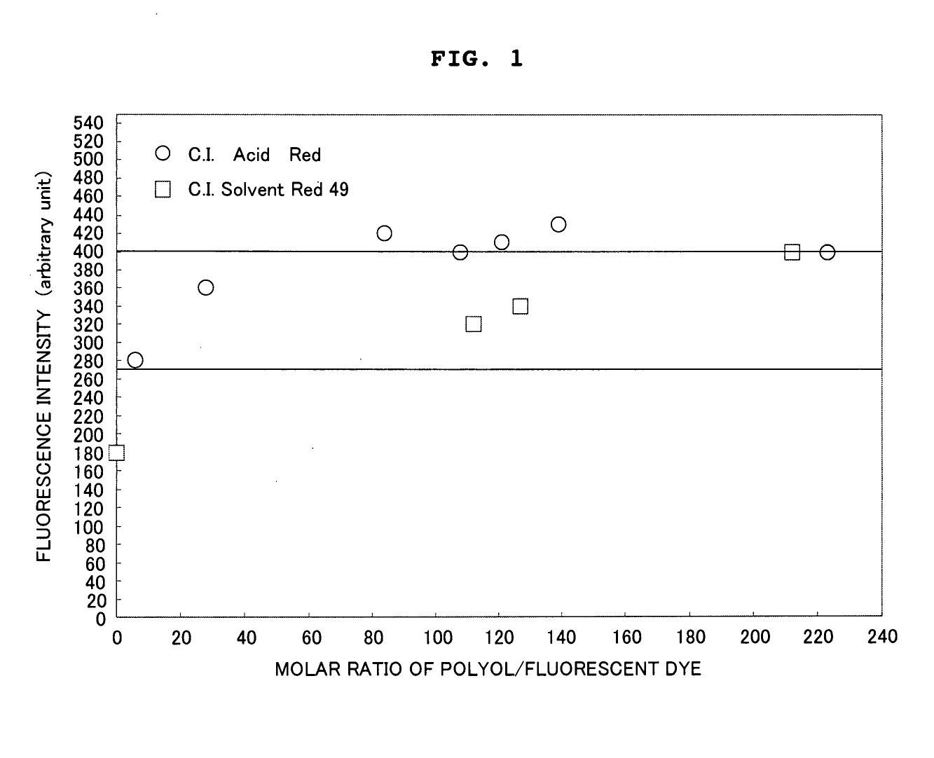

Examples 1 to 3 and Examples 8 to 11 are common to one another in that C.I. Acid Red 52 is used as the fluorescent dye. The relationship between the fluorescence intensity and the molar ratio of polyol (having the distance between oxygen and oxygen substantially equal to or longer than that of the xanthene skeleton) to C.I. Acid Red 52 is plotted in FIG. 1. It is appreciated that the fluorescence intensity is increased as the molar ratio of polyol to C.I. Acid Red 52 is increased until arrival at molar ratios of 6 to 84. Considering the shape of the graph and the fluorescence intensities of the inks of Comparative Examples 1 and 2 (190 and 230 respectively), it is understood that the effect to increase the fluorescence intensity appears at least at a molar ratio of 6. It is considered that the significant minimum molar ratio is less than 6. On the other hand, Examples 4 to 6 and Comparative Example 4 are common to one another in that C.I. Solvent Red 49 is used as the fluorescent dye. The relationship between the fluorescence intensity and the molar ratio of polyol to C.I. Solvent Red 49 is plotted in FIG. 1. It is appreciated that the fluorescence intensity is increased as the molar ratio of polyol to C.I. Solvent Red 49 is increased. It is understood that the effect to increase the fluorescence intensity reliably appears at least at a molar ratio of 112. The best effect is obtained for C.I. Acid Red 52 when the molar ratio is not less than 84 and for C.I. Solvent Red 49 when the molar ratio is not less than 212.

According to the present invention, it is possible to provide the fluorescent water base ink for ink-jet recording having the high fluorescence intensity, and the ink cartridge comprising the same.

1. A fluorescent water base ink for ink-jet recording, comprising:
a fluorescent dye having a skeleton for emitting fluorescence; and
a polyol having not less than two hydroxyl groups, wherein:
a distance between oxygen and oxygen of the two hydroxyl groups in the polyol is substantially equal to or longer than a length of the skeleton of the fluorescent dye.

2. The fluorescent water base ink for ink-jet recording according to claim 1, wherein the distance between oxygen and oxygen of the two hydroxyl groups of the polyol is not more than two times the length of the skeleton of the fluorescent dye.

3. The fluorescent water base ink for ink-jet recording according to claim 1, wherein the polyol has a number of carbon atoms of not more than 8.

4. The fluorescent water base ink for ink-jet recording according to claim 1, wherein the polyol has a content of 5 to 40% by weight.

5. The fluorescent water base ink for ink-jet recording according to claim 1, wherein the skeleton of the fluorescent dye is a xanthene skeleton.

6. The fluorescent water base ink for ink-jet recording according to claim 1, wherein the fluorescent dye is at least one selected from the group consisting of C.I. Acid Red 52, C.I. Solvent Red 49, and C.I. Solvent Yellow 94.

7. The fluorescent water base ink for ink-jet recording according to claim 1, wherein the polyol is at least one selected from the group consisting of 1,3-propanediol, 1,4-butanediol, 1,5-pentanediol, 1,6-hexanediol, 1,7-heptanediol, 1,8-octanediol, 1,2,4-butanetriol, and 1,2,6-hexanetriol.

8. The fluorescent water base ink for ink-jet recording according to claim 1, wherein the polyol is at least one selected from the group consisting of 1,5-pentanediol, 1,6-hexanediol, and 1,2,6-hexanetriol.

9. The fluorescent water base ink for ink-jet recording according to claim 1, wherein a molar ratio of the polyol to the fluorescent dye is not less than 6.

10. The fluorescent water base ink for ink-jet recording according to claim 1, wherein a molar ratio of the polyol to the fluorescent dye is not less than 212.

11. The fluorescent water base ink for ink-jet recording according to claim 1, further comprising water and glycerol.

12. An ink cartridge comprising the ink as defined in claim 1.
